(19) United States
(12) Patent Application Publication
(10) Pub. No.: US 2019/0216023 A1
(43) Pub. Date: Jul. 18, 2019

(54) SYSTEM AND METHOD FOR COVERING TRAFFIC BARRIERS

(71) Applicant: Brad Bonessi, Miami Beach, FL (US)

(72) Inventor: Brad Bonessi, Miami Beach, FL (US)

(21) Appl. No.: 16/245,319

(22) Filed: Jan. 11, 2019

Related U.S. Application Data
(60) Provisional application No. 62/616,506, filed on Jan. 12, 2018.

(51) Int. Cl. A01G 9/02; E01F 15/08; A01G 9/20; A01G 9/24; A01G 27/00; A01C 23/04; G09F 23/00; B08B 3/02; B08B 3/04

(52) U.S. Cl. CPC A01G 9/025; E01F 15/08; A01G 9/20; A01G 9/247; B08B 3/04; A01C 23/042; A01G 27/003; G09F 23/00; B08B 3/02; A01G 27/001

(57) ABSTRACT

The invention herein discloses a traffic barrier having a wall portion and a base, said wall portion configured to attach an interchangeable framework, which has thereon a cover containing at least one of an artificial that is synthetic representation of a living organism, or a live plant of the kind exemplified by flowers, trees, shrubs, herbs, grasses, ferns, and mosses, to improve the aesthetic appeal of the barrier, at least one utilitarian object to further the visibility of the barrier to oncoming traffic, and at least one object to improve the preservation of the barrier.

### RELATED APPLICATION

This application claims the priority benefit under 35 U.S.C. § 119(e) for U.S. patent application Ser. No. 62/616,506, entitled System And Method For Covering Traffic Barriers, filed Jan. 12, 2018, the entire disclosure of which is hereby incorporated by reference.

### FIELD OF THE INVENTION

The present invention relates to traffic barriers in combination with attachments for mounting aesthetic synthetic foliage and lighting.

### BACKGROUND OF THE INVENTION

A Jersey barrier, or Jersey wall, is a modular concrete or plastic barrier employed to separate lanes of traffic. The barrier is designed to minimize vehicle damage in cases of incidental contact while still preventing the crossover case of a head-on collision. Jersey barriers are also used to reroute traffic and protect pedestrians and workers during highway construction, as well as temporary and semi-permanent protections against suicide vehicle bombs. A Jersey barrier is also known in the western United States as K-rail, or K-wall, or temporary concrete traffic barriers, or Jersey bump. Plastic water-filled barriers of the same general shape are also now commonly called Jersey barriers.

A Jersey barrier is typically fabricated from steel reinforced concrete that has been molded in a steel form. The typical profile has a narrow flat top, concave sides extending down to a wide base. The angle between the flat top and concave sides is about 84 degrees. More particularly, the commonly seen shape extends upward, whereby the first 2 inches from the pavement rises vertically, the next 10 inches rises at a 55-degree angle, and the remainder at the 84-degree angle (as measured from horizontal). A typical barrier weighs about 8,000 pounds.

As a result of the wide spread acceptance of this design and the need to have many suppliers due to transportation problems, a substantial investment in steel forms has been made by a large number of precast concrete products manufacturers. In North America alone, the investment represents many millions of dollars. Therefore any improvements, as to the exterior appearance, must be adapted to the Jersey barrier design that has existed over several decades.

Representative of improvement attempts are: U.S. Pat. No. 5,453,916, issued Sep. 26, 1995, which discloses a modular safety lighting system that is designed specifically for Jersey barriers; U.S. Pat. No. 5,443,324, issued Aug. 22, 1995, which discloses a pinning system for pinning one barrier to the next to provide a continuous barrier; and U.S. Pat. No. 4,946,306, issued Aug. 7, 1990, which discloses a plastic version of the Jersey barrier.

However, concrete remains the first choice for construction of Jersey barriers and the design remains conventional. On the other hand, concrete is vulnerable to a wide range of chemical exposure, including road salt. Repair to concrete or the replacement of these concrete structures costs millions of dollars each year. In addition, it is relatively unsightly.

Since the New York World Trade Tower attack on Sep. 11, 2001, there has been a proliferation of Jersey barriers as an effective means to thwart terrorists who may use vehicles to assist in terroristic activities. Similarly, the use of other forms of barriers having differing shapes and sizes are also used for traffic control and protection of pedestrians, such as barrels or bollards, such as may be found in areas where a road has been closed off to road traffic to encourage foot and cycle traffic in parks and shopping areas. The use of barriers throughout society makes for an unsightly blight upon neighborhoods. As such, there is a need to fashion barriers that may serve the aesthetic tastes of various communities. However, the complexities of maintenance so as to provide protection against factors such as chemical deterioration of the concrete and the special requirements for ensuring that the barriers are visible to a wide range of drivers who may potentially encounter them, requires special consideration. Therefore, an apparatus needed to address both the aesthetic and the maintenance requirements in the deployment and widespread use of the barriers.

### SUMMARY OF THE INVENTION

The invention herein discloses a traffic barrier having a wall portion and a base, said wall portion configured to attach an interchangeable framework, which has thereon a cover containing at least one of an artificial object that is a synthetic representation of a living organism, or a live plant of the kind exemplified by flowers, trees, shrubs, herbs, grasses, ferns, and mosses, to improve the aesthetic appeal of the barrier, at least one utilitarian object to further the visibility of the barrier to oncoming traffic, and at least one object to improve the preservation of the barrier.

One non-limiting embodiment of the invention includes at least one aesthetic object, such as a poster, sign, synthetic turf or spreading floral arrangement that substantially covers one or more of the sides or top portion of the framework.

Another non-limiting embodiment of the invention includes a cover that is releasably fastened to the framework via a plurality of fasteners such that the framework or the wall portioned attachment may be interchanged, or may be replaced or repaired, in whole or in part. The wall portion may be constructed of any rigid or semi-rigid material, including but not limited to plastic, wire, or metal, and configured in a manner so permit the barrier cover to be secured. By way of example, and not limitation, the wall portion may be a rigid wire mesh, which may be permanently attached to one or more framework sections assembled from tubing, pipes or rigid beams; or alternatively may be attachable to framework sections using, by way of example and not limitation, nuts and bolts, hooks, latches, clips, clamps, fasteners, tongue and groove joints or other interlocking mechanisms.

Another non-limiting embodiment of the invention is disclosed, wherein the barrier has a cross-sectional profile that corresponds to a Jersey barrier. Alternatively, another non-limiting embodiment the invention has a cross-sectional profile that corresponds to a barrel, bollard or other substantially cylindrical shaped barrier. In yet another non-limiting embodiment, the invention includes a series of light emitting devices that serve one or more of aesthetic purpose or warnings to oncoming vehicles.

Still another non-limiting embodiment of the invention includes a system to maintain the cleanliness of the synthetic turf or spreading floral arrangement free of chemicals, residue, dirt and debris.

Still another non-limiting embodiment of the invention includes a system to water, feed and nourish the living organism.

In another non-limiting embodiment, the framework and some or all of its constituent parts also serve the dual purpose of providing a framework for attaching a barrier cover, and also serves as a system for the collection and circulation of liquids, such as rainwater, used for irrigation, plant nourishment, barrier cover cleaning.

### BRIEF DESCRIPTION OF THE DRAWINGS

FIG. 1 shows a completed assembly of a traffic barrier having thereon a plant overlay, lights and solar photoelectric cell for power generation in accordance with an embodiment of the present invention.

FIG. 2A, FIG. 2B and FIG. 2C, show a top view and two end views, respectively, of a Jersey barrier for the application of a plant overlay, lights and silicon photoelectric cell in accordance with an embodiment of the present invention.

FIG. 3 shows a perspective view of an assembled framework sections in association with a barrier in accordance with an embodiment of the present invention.

FIG. 4 shows a perspective view of a partial side surface of the plant overlay and its insertion onto a framework in accordance with an embodiment of the present invention.

FIG. 5A, FIG. 5B, and FIG. 5C show a plan side view and two end views of a framework section in accordance with an embodiment of the present invention.

FIG. 6 shows a perspective view of an unassembled framework sections in association with a barrier in accordance with an embodiment of the present invention.

FIG. 7 shows a top plan view of a framework section with a plant overlay and framework section without an overlay in accordance with an embodiment of the present invention.

### DESCRIPTION OF PREFERRED EMBODIMENT

The present invention will now be described more fully hereinafter with reference to the accompanying drawings, in which preferred embodiments of the invention are shown. The following detailed description includes the best mode of carrying out the invention, which may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. Each part or function is assigned, even if structurally identical to another part, a unique reference number, wherever that part is shown in the drawing figures.

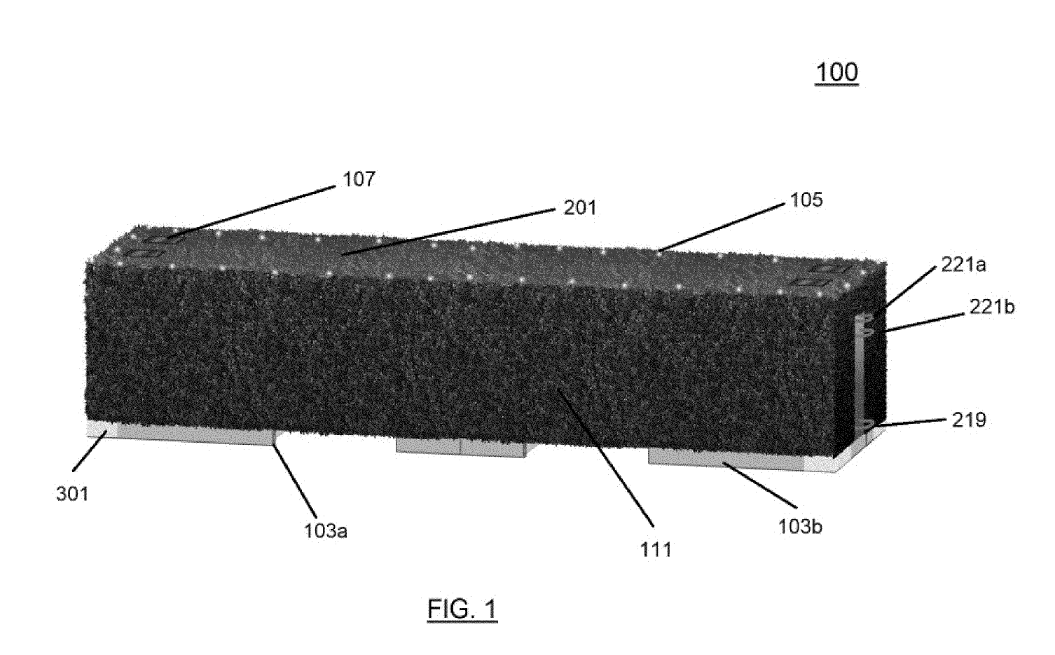

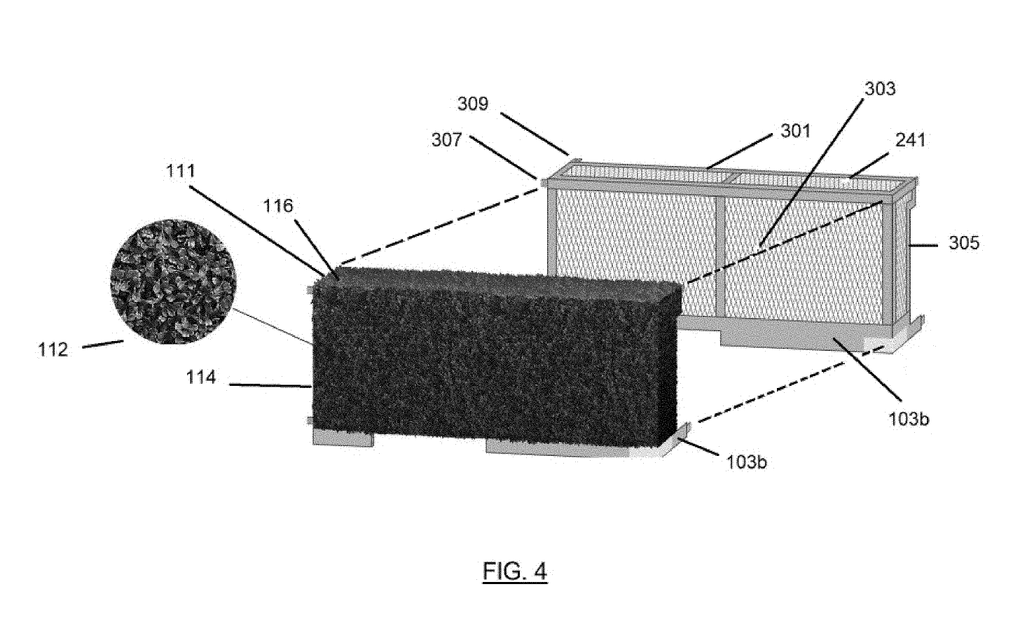

Referring to FIG. 1, an apparatus 100 relates to a traffic barrier 201 having thereon a plant overlay 111, lights 105 and solar photoelectric cell 107 for power generation of the lights and any peripherals that may be employed such as pumps for irrigation or cleaning debris from the plant overlay. In one non-limiting embodiment the power generation may be provided for by a connection to any local power line, power generator or battery. The plant overlay 111 is incorporated onto a framework 301 having a base structure. More particularly the framework includes a base structure 103a, 103b, and a framework wall structure 303 (FIG. 4), wherein the wall portion 303, is configured to attach an interchangeable framework 301 (FIG. 4), which has thereon a cover 111 containing at least one of an artificial or synthetic representation of a plant or in fact a living organism, either of the kind exemplified by flowers, trees, shrubs, herbs, grasses, ferns, and mosses, to improve the aesthetic appeal of the barrier 201, and at least one utilitarian object, such as lights 105, to further the visibility of the barrier to oncoming traffic, and in one embodiment at least one object to improve the preservation of the barrier, such as a means for washing off debris (not shown).

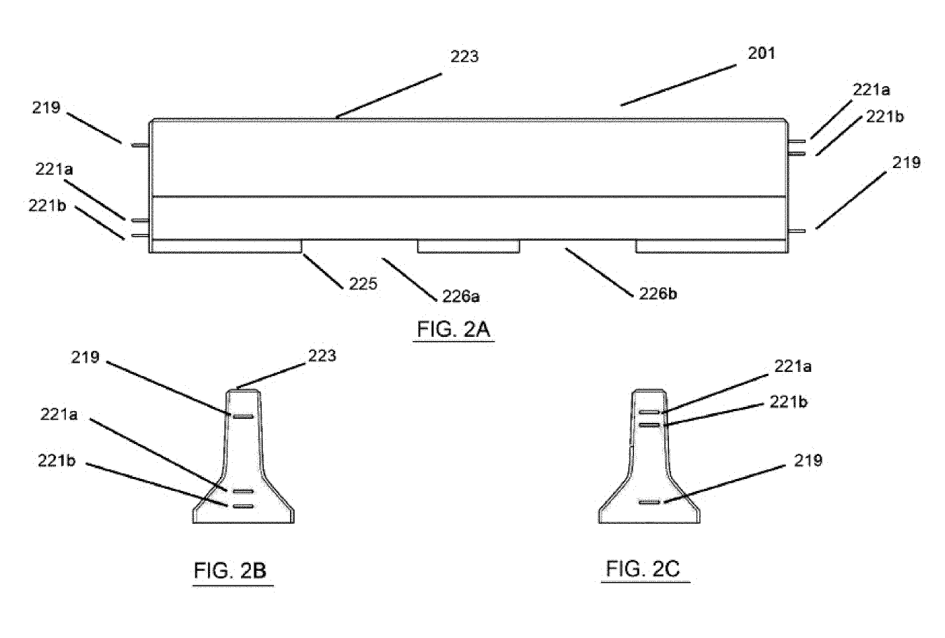

FIG. 2A, FIG. 2B and FIG. 2C, show a front view and end views respectively of a Jersey barrier 201, for the incorporation of a plant overlay, decorative or warning lights and silicon photoelectric cell, to power the lights and other accoutrements, in accordance with an embodiment of the present invention. The barrier 201 has a top surface 223 to be covered, and a base 225 that rests on a road surface. Two rectangular notches 226a, 226b, at the bottom (through the short axis) allow for forklift-style lifting by front-end loaders. Barriers meant for short-term placement, e.g. as security barriers, include U-bends or steel rebar loops 221a, 221b and 219, which protrude from and are embedded into the end surfaces of the barrier 201 for rapid hook-cable and pin system of the barrier 201 and other abutted concatenated barriers (not shown).

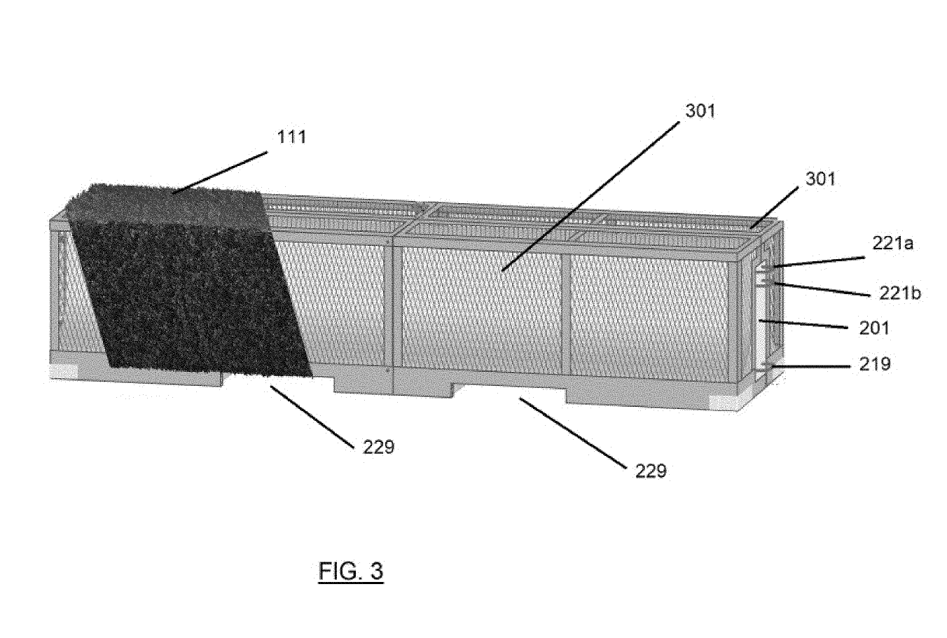

FIG. 3 is a perspective view of a partial front surface of the plant overlay cover 111 and its attachment to the framework 301 in accordance with an embodiment of the invention. There are four framework 301 sections, as described below, which serve to encapsulate the barrier 201, with when joined as describe below allow for an opening for the U-bends or steel rebar loops 221a, 221b and 219. In an alternate embodiment, one or more of the rebar loops 221a, 221b and 219 may serve as an anchor for securing the framework to the barrier (not shown). By way of example and not limitation, one or more of framework sections 240a, 240b or 240c, may have a mechanism for securing the framework to the barrier, such as one or more of a hooking, locking or clamping mechanisms (not shown) that allow the framework to withstand hurricane force winds.

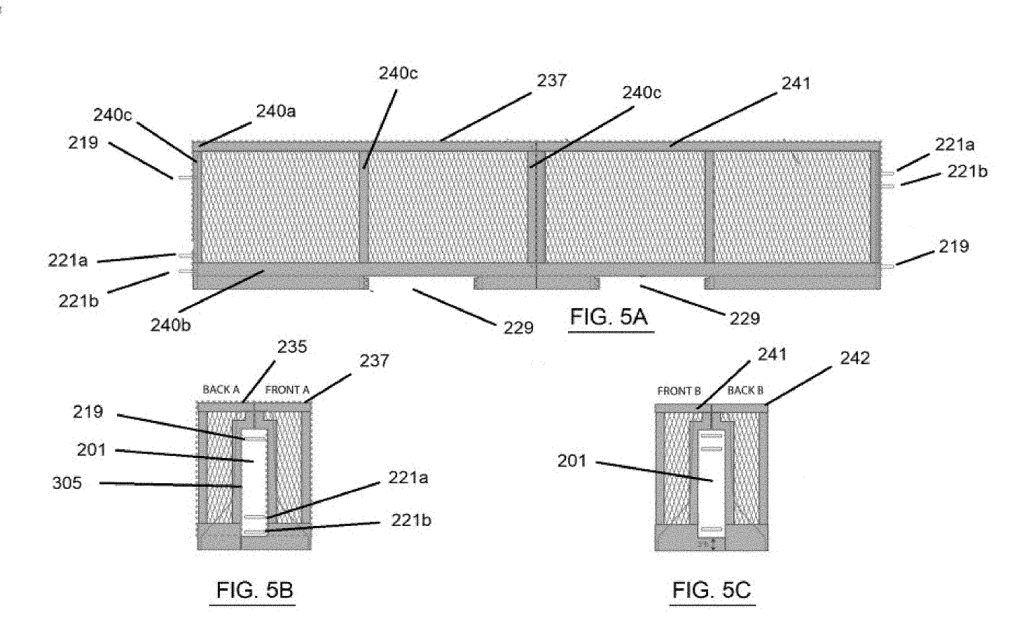

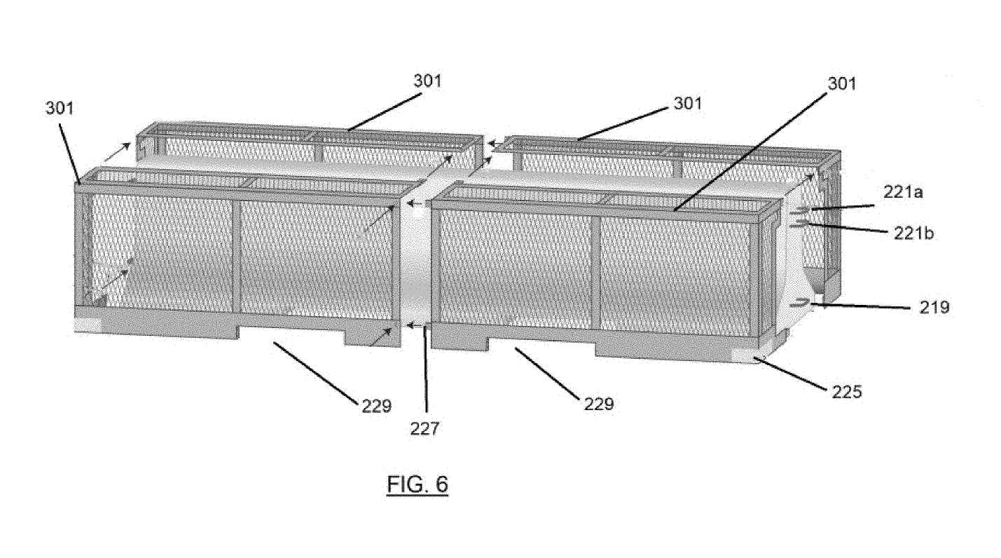

Taking FIG. 4, FIG. 5A, FIG. 5B, FIG. 5C and FIG. 6 together, the framework 301 section is constructed of a weatherproof metal frame 237, typically anodized aluminum, with a clear, blasted/etched finish. The frame of the framework serves as structure to attach an expanded aluminum flattened metal panel 241, having a generally mill/raw finish. As shown in FIG. 5A, framework 301 metal frame 237 includes both horizontal members 240a, 240b and vertical members 240c that secures the metal panel 241. The bottom horizontal member of the framework serves as the base structure 103a (FIG. 1), 103b (FIG. 4), which may be covered in reflective high visibility tape.

Each framework 301 section runs about one-half the length of the barrier 201, each section consist of a mating pair, such as a right front section 241 and right rear section 242 or a left front section 237 and a left rear section 235. See, FIG. 5B and FIG. 5C. In FIG. 4, a right framework wall section 303 is associated with a right fitting mating cover 111. The cover has a side surface 114 and a top surface 116. Likewise for each of the remaining framework sections, i.e., rear right, front left, rear left, a corresponding mating cover 111 will overlay a corresponding framework section. The respective framework paired sections fastener tabs 307, 309, joins the paired adjacent sections such as front right, rear right, to the other framework sections front left, rear left. A rectangular jog 305 is designed to fit into the barrier 201 and expose the U-bends or steel rebar loops 221a, 221b and 219. See, FIG. 5B.

The cover 111 may be composed of a synthetic facsimile of a plant, such as artificial boxwood 112, which is waterproof, weatherproof and UVA sun proof. The plant can be changed out depending on a number of factors, including season of the year, holidays, or when the cover becomes too soiled. In some instances the plant may be live, that is grows within the framework 301, as do certain plant life. In this case the plants would depend on rainfall for irrigation. Alternatively the apparatus may include rain collectors and associated pumps to irrigate the plant during runs of arid weather.

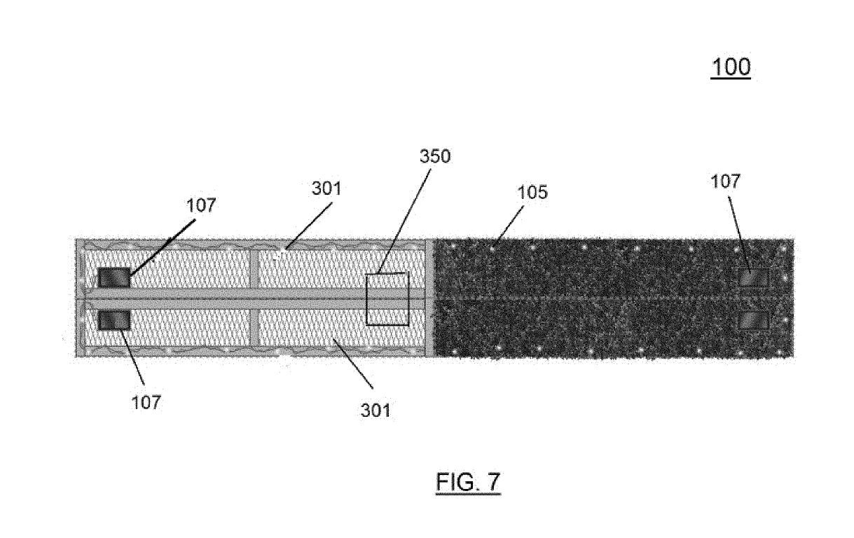

Referring to FIG. 5A, in an alternate embodiment (not shown), certain sections of the framework, also serve as system for the collection, flow and distribution of fluids, such as water, rainwater, or a mixture of fluids that may serve to clean the barrier cover, and/or nourish live plants. By way of example and not limitation, the framework members 240a, 240b, and/or 240c, may additionally, but optionally serve as a system of conduit, rectangular tubing or cylindrical pipes that have a plurality of holes for collecting rainwater and then transports the rainwater to the base 103 (FIG. 4) or other reservoir (not shown) and thereafter recycles and distributes rainwater by another set of conduit, rectangular tubing or cylindrical pipes, which are also part of the framework members 240a, 240b and/or 240c, by a pump 350 (FIG. 7) to a series of nozzles (not shown) for cleaning the barrier cover or watering live plants. The pump 350 may be programmable so as to activate when a sufficient amount of rainwater is present in the system and to deactivate within certain configurable parameters.

FIG. 7 is a top view of the apparatus 100 showing the location, on the topside of the barrier as attached to the framework 301, of the solar cells for 107 for powering LED lights. In another embodiment, the invention includes a system to maintain the cleanliness of the synthetic turf or spreading floral arrangement free of dirt and debris. By way of illustration and not limitation, a pump and reservoir 350 is included, in the event there is a need to keep the cover 111 clean. The piping for this embodiment is not shown. Both of these embodiments are implemented using apparatuses and techniques of those or ordinary skill in the art of irrigating small gardens.

In another non limiting embodiment related to maintenance, the invention, as shown in FIG. 1 includes a diagnostic system (not shown) that determines if the apparatus 100 and its subsystems are functioning properly and whereby a maintenance system (not shown) can turn-on and turn-off, the apparatus 100 lighting and irrigation systems. Each of the diagnostic and the maintenance systems may be controlled remotely, such as, by example and not limitation, a controller (not shown) having a communications link that employs smartphone technology and GPS technology for locating apparatus 100 from a central maintenance location.

While the foregoing invention has been described with reference to the above embodiments, additional modifications and changes can be made without departing from the spirit of the invention. Accordingly, such modifications and changes are considered to be within the scope of the specification.

I claim:

1. A traffic barrier comprising a wall portion and a base, said wall portion configured to attach an interchangeable framework, which has thereon a cover containing (1) one or more of (a) a synthetic representation of a living organism, or (b) a live plant of one or more of a (i) flower, (ii) tree, (iii) shrub, (iv) herb, (v) grass, (vi) fern, and (vii) mosses, and (2) one or more of (a) lights or (b) reflectors, to further the visibility of the barrier to oncoming traffic, and (3) one or more of a (a) water system or (b) fertilizer system, for preserving the appearance of the barrier.

2. The barrier as in claim 1, further including at least one aesthetic object, such as a poster, sign, synthetic turf or spreading floral arrangement that substantially covers one of the sides or top portion of the framework.

3. The barrier as in claim 1, further including a cover that is releasably fastened to the framework via a plurality of fasteners such that the framework or the wall portioned attachment may be interchanged.

4. The barrier as in claim 1, wherein the barrier has a cross-sectional profile that corresponds to a Jersey barrier.

5. The barrier as in claim 1, wherein the barrier has a cross-sectional profile that corresponds to a substantially cylindrical barrier.

6. The barrier as in claim 1, further including a series of light emitting devices that serve one or more of aesthetic purpose or warnings to oncoming vehicles.

7. The barrier as in claim 1, further including a system for removing dirt, debris or chemical residue from the traffic barrier, including one or more pumps, hoses, nozzles, sprayers, and a suitable cleaning fluid.

8. The barrier as in claim 1, further including a system to irrigate the living organism.

9. The barrier as in claim 1, further including a diagnostic system for determining if the barrier and its subsystems are functioning properly.

10. The barrier as in claim 1, further including a maintenance system to turn-on and turn-off, the barrier lighting.

11. The barrier as in claim 1, further including a maintenance system to turn-on and turn-off, the irrigation system.

12. The barrier as in claim 1, wherein one of a diagnostic or maintenance system may be controlled remotely.

13. A traffic barrier comprising a wall portion configured to attach to an interchangeable framework whereby (1) one or more sections of the framework includes a system of pipes having a plurality of holes for collecting and recycling rainwater, and (2) a cover containing one or more of a (i) flower, (ii) tree, (iii) shrub, (iv) herb, (v) grass, (vi) fern, and (vii) mosses, and (3) one or more (a) lights or (b) reflectors, to further the visibility of the barrier to oncoming traffic.

14. A method for construction a traffic barrier comprising (1) erecting a wall portion situated on a base, (2) attaching said wall portion to an interchangeable framework, (3) covering the framework with one or more of (a) a synthetic representation of a living organism, or (b) a live plant of one or more of a (i) flower, (ii) tree, (iii) shrub, (iv) herb, (v) grass, (vi) fern, and (vii) mosses, and (c) one or more (i) lights or (ii) reflectors, to further the visibility of the barrier to oncoming traffic, and (4) preserving the appearance of the barrier utilizing (a) one or more of a (i) water system or (ii) fertilizer system.

15. The method for construction as in claim 14, further including releasing the fastened covering of the framework.

16. The barrier as in claim 1, wherein the barrier has a cross-sectional profile that corresponds to a Jersey barrier.

17. The method for construction as in claim 14, further including lighting emitting devices that serve one or more of aesthetic purpose or warnings to oncoming vehicles.

18. The method for construction as in claim 14, further including removing dirt, debris or chemical residue from the traffic barrier.

19. The method for construction as in claim 14, further including irrigating the living organism.

20. The method for construction as in claim 14, further including a diagnosing if the barrier and its subsystems are functioning properly.
